(19) United States
(12) Patent Application Publication
(10) Pub. No.: US 2013/0237641 A1
(43) Pub. Date: Sep. 12, 2013

(54) PROCESS USING BISPHENOL A AMINATED AND ALKOXYLATED DERIVATIVE AS DEMULSIFIER

(71) Applicants: Isabelle Riff, Richterswil (CH); Thiago Alonso, Sao Paulo (BR); Ronald Van Voorst, Vogelwaarde (NL)

(72) Inventors: Isabelle Riff, Richterswil (CH); Thiago Alonso, Sao Paulo (BR); Ronald Van Voorst, Vogelwaarde (NL)

(73) Assignees: DOW BRASIL SUDESTE INDUSTIRAL LTDA FILIA POLIESTIRENO, Sao Paulo (BR); DOW GLOBAL TECHNOLOGIES LLC, Midland, MI (US)

(21) Appl. No.: 13/885,217

(22) PCT Filed: Nov. 15, 2011
(86) PCT No.: PCT/US11/60774

§ 371 Date: May 14, 2013

Related U.S. Application Data
(60) Provisional application No. 61/414,636, filed on Nov. 17, 2010.

(51) Int. Cl. B01D 17/04

(52) U.S. Cl. CPC B01D 17/047
USPC 523/414

(57) ABSTRACT

Embodiments of the present disclosure include a method of destabilizing a crude oil-water emulsion that includes adding to the crude oil-water emulsion a demulsifier obtained by an alkoxylation reaction of an aminated epoxy adduct, the aminated epoxy adduct obtained by a reaction of an epoxy resin and an amine. In one or more embodiments, the alkoxylation reaction includes reacting C2 to C4 alkylene oxides with the aminated epoxy adduct.

### FIELD OF DISCLOSURE

This disclosure relates to crude-oil production, and in particular the use of a demulsifier in emulsions found in crude-oil production.

### BACKGROUND

Certain techniques used in extracting crude-oil from an oil field can produce an emulsion of the crude-oil and saline water. The emulsion is an undesirable product that needs to be broken into a water phase and an oil phase. Once broken, the oil phase can then go on for further processing.

A variety of techniques can be used in trying to destabilize the emulsion. Such methods include thermal, chemical, and/or electrostatic methods. With respect to chemical techniques, demulsifiers (also known as “emulsion destabilizers”) are chemical compounds that can be used to destabilize such emulsions. Demulsifiers are surfactant like molecules that are active at the boundary surface between emulsion components, e.g. the water and the oil, and are capable to provoke, within a very short time, the required separation of the emulsion components.

While demulsifiers do currently exist, the increasing complex characteristic of produced crude-oils, e.g. asphalt/bitumen and paraffin content in heavy crudes, and the every increasing water fraction needed to extract the crude-oil requires developing further technologies to the already existing demulsifiers.

### SUMMARY

The present disclosure provides one or more embodiments of a method of destabilizing a crude oil-water emulsion that includes adding to the crude oil-water emulsion a demulsifier obtained by an alkoxylation reaction of an aminated epoxy adduct, the aminated epoxy adduct obtained by a reaction of an epoxy resin and an amine. In one or more embodiments, the epoxy resin can be a di-epoxy resin. In one or more embodiments, the aminated epoxy adduct can be a di-aminated epoxy adduct.

In one or more embodiments, adding to the crude oil-water emulsion includes adding 0.0001 weight percent (wt. %) to 5 wt. % of the demulsifier based on a total weight of the crude oil-water emulsion. In one or more embodiments, the demulsifier of the present disclosure has a weight average molecular weight of 3,500 to 11,000.

In one or more embodiments, the alkoxylation reaction used to form the demulsifier of the present disclosure includes reacting C2 to C4 alkylene oxides with the aminated epoxy adduct. In one or more embodiments, reacting the C2 to C4 alkylene oxides with the aminated epoxy adduct includes making the reaction with a molar ratio of C2 alkylene oxide to C3 alkylene oxide and/or C4 alkylene oxide (e.g., one of a C3 alkylene oxide, a C4 alkylene oxide or a mixture of C3 alkylene oxide and C4 alkylene oxide) from 0 mole percent to 100 mole percent C2 alkylene oxide to 100 mole percent to 0 mole percent of C3 alkylene oxide and/or C4 alkylene oxide. In one or more embodiments, reacting the C2 to C4 alkylene oxides with the aminated epoxy adduct includes making the reaction with a the molar ratio of C2 alkylene oxide to C3 alkylene oxide and/or C4 alkylene oxide (e.g., one of the C3 alkylene oxide, the C4 alkylene oxide or the mixture of C3 alkylene oxide and C4 alkylene oxide) from 6.5 mole percent to 57 mole percent C2 alkylene oxide to 93.5 mole percent to 43 mole percent of C3 alkylene oxide and/or C4 alkylene oxide.

In one or more embodiments, the amine can be a branched monoamine selected from the group consisting of di-n-butylamine, di-n-propylamine, di-n-pentylamine, di-n-hexylamine, and combinations thereof.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### Definitions

As used herein, the terms “a,” “an,” “the,” “one or more,” and “at least one” are used interchangeably and include plural referents unless the context clearly dictates otherwise.

Unless defined otherwise, all scientific and technical terms are understood to have the same meaning as commonly used in the art to which they pertain. For the purpose of the present disclosure, additional specific terms are defined throughout.

The terms “comprises,” “includes” and variations of these words do not have a limiting meaning where these terms appear in the description and claims. Thus, for example, a process that comprises “a” demulsifier can be interpreted to mean a process that includes “one or more” demulsifiers. In addition, the term “comprising,” which is synonymous with “including” or “containing,” is inclusive, open-ended, and does not exclude additional un-recited elements or process steps.

As used herein, the term “and/or” means one, more than one, or all of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

As used herein, the term “water” can include, for example, a brine, a connate water, surface water, distilled water, carbonated water, sea water and a combination thereof. For brevity, the word “water” will be used herein, where it is understood that one or more of “brine,” “connate water,” “surface water,” “distilled water,” “carbonated water,” and/or “sea water” can be used interchangeably.

As used herein, a “demulsifier” refers to a chemical compound that lowers the interfacial tension between at least two liquids in an emulsion and is capable of provoking the separation of the emulsion into at least two liquid phases.

As used herein, an “emulsion” refers to a mixture of two immiscible liquids, where one liquid phase (the dispersed liquid phase) is dispersed in the other liquid phase (the continuous liquid phase).

As used herein, “destabilizing” an emulsion refers to the breaking of the emulsion into its separate liquid phases by at least one chemical demulsifier. According to the present disclosure, destabilizing an emulsion can be tested with what is referred to in the art as the “bottle-test.” The bottle-test can be performed on a sample of a crude oil-water emulsion. A predetermined volume of the crude oil-water emulsion is introduced into a calibrated bottle. The bottle is then place in a temperature bath (e.g., a water bath) at a predefined temperature (e.g., the temperature of the crude oil production well). A demulsifier is then introduced into the emulsion (with or without the use of a solvent) and the content of the bottle mixed with successive rotation in a reproducible manner. The volume of the separated water and oil is then read at various time intervals until the volume of the settled water stops increasing. The clarity of the water and presence of sludge, filament and cloudiness can be noted at the end of the test. The test can be repeated at several concentrations of the demulsifier in order to determine a suitable concentration for use as a demulsifier.

As used herein, the term “oil” refers to a naturally occurring liquid consisting of a complex mixture of hydrocarbons of various molecular weights and structures, and other organic compounds, which are found in geological formations beneath the earth's surface. “Oil” is also known, and may be referred to, as petroleum and/or crude oil.

As used herein, the term “concentration” refers to a measure of an amount of a substance, such as a demulsifier as discussed herein, contained per unit volume of solution. As used herein, parts-per-million (ppm) is used as one measure of concentration in which a given property exists at a relative proportion of one part per million parts examined, as would occur if a demulsifier was present at a concentration of one-millionth of a gram per gram of emulsion.

As used herein, the term “integer” is a member of the set of positive whole numbers {1, 2, 3, . . . }.

As used herein, the term “alkyl” means a saturated linear, i.e., straight chain, cyclic, i.e., cycloaliphatic, or branched monovalent hydrocarbon group including, e.g. methyl, ethyl, n-propyl, isopropyl, t-butyl, amyl, heptyl, dodecyl, octadecyl, 2-ethylhexyl, and the like.

As used herein, the term “alkylene” means an unsaturated, linear or branched monovalent hydrocarbon group with one or more olefinically unsaturated groups (i.e., carbon-carbon double bonds), such as a vinyl group.

As used herein, the term “cyclic group” means a closed ring hydrocarbon group that is classified as an alicyclic group, aromatic group, or heterocyclic group.

As used herein, the term “alicyclic group” means a cyclic hydrocarbon group having properties resembling those of aliphatic groups.

As used herein, the term “alkoxide chain” means a polymeric chain composed of repeating alkylene oxide units.

As used herein, the term “alkyl oxide” and “alkylene oxide” means a cyclic ether with three ring atoms (two carbon and one oxygen) on which one of the carbon atoms may be substituted by an alkyl chain.

### DETAILED DESCRIPTION

Embodiments of the present disclosure include one or more embodiments of a method of destabilizing a crude oil-water emulsion. For one or more embodiments, the method includes adding to the crude oil-water emulsion a demulsifier obtained by an alkoxylation reaction of an aminated epoxy adduct.

During oil production, oil can be produced in combination with water as the crude oil-water emulsion. As discussed herein, the crude oil-water emulsion is an undesirable product that needs to be destabilized. Destabilizing the emulsion can be performed for economic and technical reasons. For example, destabilizing the emulsion can be performed to avoid the uneconomical transport of water, to minimize corrosion problems, and to reduce energy consumption for transport pumps. Additionally, in order for the oil to be suitable for pipeline transportation it is necessary to reduce the water content to below specified industry standards.

Demulsifiers are chemical compounds that can orient at the crude oil-water interface and separate the emulsion into a water phase and an oil phase. Previous methods to destabilize emulsions utilize demulsifiers that can require a long residence-time in a settle vessel for the demulsification to occur, e.g. 4 hours (hrs) or longer. Additionally, previous methods use demulsifiers as solutions in hydrocarbon or oxygenated solvents and can increase the cost and decrease the safety of the demulsification.

For one or more embodiments, the method includes destabilizing the crude oil-water emulsion. The method includes adding to the crude oil-water emulsion a demulsifier obtained by an alkoxylation reaction of an aminated epoxy adduct, where the aminated epoxy adduct is obtained by a reaction of an epoxy resin and an amine.

For one or more embodiments, the epoxy resin used in the present disclosure can be a di-epoxy resin represented by a compound of Formula I:

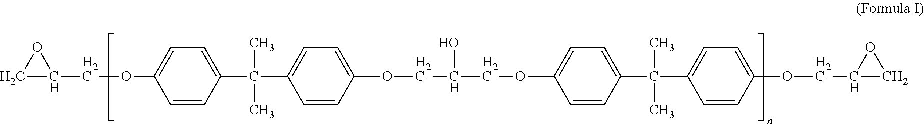

where n is an integer having a value from 0 to 6.

For one or more embodiments, examples of the epoxy resin used to prepare the aminated epoxy adduct can include, but are not limited to, the diglycidyl ethers of: resorcinol; 4,4′-isopropylidenediphenol (bisphenol A); 4,4′-dihydroxybenzophenone (bisphenol K); 1,1-bis(4-hydroxyphenyl)-1-phenylethane (bisphenol AP); dihydroxydiphenylmethane (bisphenol F); 3,3′,5,5′-tetrabromobisphenol A; 4,4′-thiodiphenol (bisphenol S); 4,4′-sulfonyldiphenol; 4,4′-dihydroxydiphenyl oxide; 3-phenylbisphenol A; 3,3′,5,5′-tetrachlorobisphenol A; 3,3′-dimethoxybisphenol A; dipropylene glycol; poly(propylene glycol)s; and thiodiglycol.

Other examples of the epoxy resin can include, but are not limited to, the triglycidyl ether of tris(hydroxyphenyl)methane; the triglycidyl ether of p-aminophenol; the tetraglycidyl ether of 4,4′-diaminodiphenylmethane; the polyglycidyl ether of a phenol or substituted phenol-aldehyde condensation product (novolac); and the polyglycidyl ether of a dicyclopentadiene or an oligomer thereof and phenol or substituted phenol condensation product. Additional examples of the epoxy resin can include, but are not limited to, the advancement reaction products of the aforesaid polyglycidyl ethers with aromatic polyhydroxyl- or polycarboxylic acid containing compounds including, e.g., bisphenol A (4,4′-isopropylidenediphenol); o-, m-, p-dihydroxybenzene; 2,4-dimethylresorcinol; 4-chlororesorcinol; tetramethylhydroquinone; 1,1-bis(4-hydroxyphenyl)ethane; bis(4,4′-dihydroxyphenyl)methane; 4,4′-dihydroxydiphenyl ether; 3,3′,5,5′-tetramethyldihydroxydiphenyl ether; 3,3′,5,5′-dichlorodihydroxydiphenyl ether; 4,4′-bis(p-hydroxyphenylisopropyl)diphenyl ether, 4,4′-bis(p-hydroxyphenoxy)benzene, 4,4′-bis(p-hydroxyphenoxy)diphenyl ether; 4,4′-bis (4(4-hydroxyphenoxy)phenyl sulfone)diphenyl ether; 4,4′-dihydroxydiphenyl sulfone; 4,4′-dihydroxydiphenyl sulfide; 4,4′-dihydroxydiphenyl disulfide; 2,2′-dihydroxydiphenyl sulfone; 4,4′-dihydroxydiphenyl methane; 1,1-bis(p-hydroxyphenyl)cyclohexane; 4,4′-dihydroxybenzophenone; phloroglucinol; pyrogallol; 2,2′,5,5′-tetrahydroxydiphenyl sulfone; tris(hydroxyphenyl)methane; dicyclopentadiene diphenol; tricyclopentadiene diphenol; terephthalic acid; isophthalic acid; and p-hydroxybenzoic acid. For one or more of the embodiments, combinations and mixtures of the epoxy resins may also be used. In one embodiment, the epoxy resin is the diglycidyl ether of 4,4′-isopropylidenediphenol (bisphenol A).

For one or more embodiments, the amine used in the present disclosure can be represented by a compound of Formula II:

R₁R₂NH (Formula II)

where R₁ and R₂ are each independently a proton, an alkyl, or a cycloalkyl group having 3 to 28 carbon atoms. For one or more embodiments, R₁ and R₂ are preferably a C3 to C10 alkyl and more preferably a C4 alkyl group.

For one or more embodiments, the amine used to prepare the aminated epoxy adduct can be selected from, but not limited to, mono- and polyamine compounds. For example, the amine can be selected from the group comprising, but not limited to, alkylamines and dialkylamines in which the number of carbon atoms in the alkyl and/or cycloalkyl chains is between 3 and 28. Examples include, but are not limited to, propylamine, dipropylamine, butylamine, dibutylamine, ethylhexylamine, diethylhexylamine, and higher homologues such as methylcyclohexylamine, cyclopentylamine, cyclohexylamine, dicyclopentylamine, and dicyclohexylamine.

Additionally, ammonia represents a case of the primary monoamines useful herein and may be conveniently used as an aqueous ammonium hydroxide solution. In one embodiment, the amine can be a diamine selected from of di-n-butylamine, di-n-propylamine, di-n-pentylamine, and di-n-hexylamine. For one or more of the embodiments, combinations and mixtures of the amines may also be used.

For one or more embodiments, reacting the epoxy resin and the amine to form the aminated epoxy adduct includes making the reaction with a molar ratio of the epoxy resin to the amine of 1.00 mole of epoxy resin to 1.00 moles of amine, preferably 1.00 mole of epoxy resin to 0.95 moles of amine, and more preferably 1.00 mole of epoxy resin to 0.945 moles of amine. In the case of a di-epoxy resin, a molar ratio of the reaction of the di-epoxy resin to the amine can be 1.00 mole of di-epoxy resin to 2.00 moles of amine, preferably 1.00 mole of di-epoxy resin to 1.90 moles of amine, and more preferably 1.00 mole of di-epoxy resin to 1.89 moles of amine.

For one or more embodiments, the reaction of the epoxy resin and the amine can be carried out in a reactor. For example, the reaction can take place in a batch reactor that includes a mixing mechanism. For one or more embodiments, the epoxy resin can be added to the reactor and the amine can be subsequently fed to the epoxy resin over a predetermined time interval. For one or more embodiments, the amine can be added to the epoxy resin over a predetermined time interval of 1 hour (hr) to 4 hours (hrs). In one embodiment, the amine can be added to the epoxy resin over 2 hrs. For one or more embodiments, the amine can be added to the epoxy resin over the predetermined time interval as a continuous stream or in batches. Alternatively, the epoxy resin and the amine can be added to the reactor simultaneously as a continuous stream or in batches.

For one or more embodiments, the reaction of the epoxy resin and the amine can have a digest time of 1 hrs to 4 hrs. As used herein, “digest time” refers to an amount of time required to react the amine added to a residual level of less than 500 parts per million (ppm). The digest time begins when the amine is added to the epoxy resin and stops when the residual level of the amine is less than 500 ppm. In one embodiment, the digest time is 2 hrs.

Reaction temperatures and reaction pressures of reacting an epoxy resin and an amine are known by those skilled in the art. For example, the reaction of the epoxy resin and the amine can have a reaction temperature of 110 degrees Celsius (° C.) to 140° C. The reaction temperature can remain constant or vary throughout the reaction of the epoxy resin and the amine.

As discussed herein, the aminated epoxy adduct can be formed by the reaction between the epoxy resin and the amine. As a non-limiting example, the following illustrates the formation of a di-aminated epoxy adduct by reacting D.E.R™ 331 (di-epoxy resin), available from the Dow Chemical Company, and dibutylamine (amine). The di-aminated epoxy adduct can be represented by a compound of Formula III:

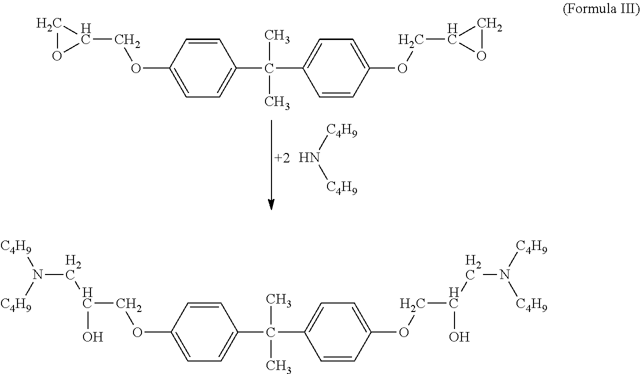

For one or more embodiments, the di-aminated epoxy adduct will have two alkoxide chains per molecule. For one or more embodiments, each alkoxide chain has a weight average molecular weight (M_{w}) between 1,440 Daltons and 5,190 Daltons.

As discussed herein, the demulsifier of the present disclosure is obtained by the alkoxylation reaction of the aminated epoxy adduct. For one or more embodiments, the alkoxylation reaction can be done by base catalysis and polymerization of alkyl oxides. For one or more of the embodiments, the alkyl oxides used in the alkoxylation reaction can be C2 to C 18 alkylene oxides. Examples of which include, but are not limited to, ethylene oxide, propylene oxide, 1,2-butylene oxide, 2,3 butylene oxide, decene oxide, styrene oxide, and combinations thereof. For one or more of the embodiments, the alkyl oxides used in the alkoxylation reaction can be C2 to C4 alkylene oxides. Preferred alkyl oxides include ethylene oxide and propylene oxide.

For one or more embodiments, reacting C2 to C4 alkylene oxides with the aminated epoxy adduct can include using only a C2 alkylene oxide, using only a C3 alkylene oxide, using only a C4 alkylene oxide, or combinations thereof (e.g., C2 alkylene oxide and C3 alkylene oxide; C2 alkylene oxide and C4 alkylene oxide; C3 alkylene oxide and C4 alkylene oxide; or C2 alkylene oxide, C3 alkylene oxide and C4 alkylene oxide). For example, reacting C2, C3 and/or C4 alkylene oxides with the aminated epoxy adduct can include making the reaction with a molar ratio of C2 alkylene oxide to C3 alkylene oxide and/or C4 alkylene oxide (e.g., one of a C3 alkylene oxide, a C4 alkylene oxide or a mixture of C3 alkylene oxide and C4 alkylene oxide) from 0 mole percent to 100 mole percent C2 alkylene oxide to 100 mole percent to 0 mole percent of C3 alkylene oxide and/or C4 alkylene oxide.

So, for example, reacting the C2 to C4 alkylene oxides with the aminated epoxy adduct can include making the reaction with a molar ratio of 0 mole percent C2 alkylene oxide to 100 mole percent C3 alkylene oxide; making the reaction with a molar ratio of 0 mole percent C2 alkylene oxide to 100 mole percent C4 alkylene oxide; making the reaction with a molar ratio of 0 mole percent C2 alkylene oxide to 100 mole percent of a mixture of C3 alkylene oxide and C4 alkylene oxide; or making the reaction with a molar ratio of 100 mole percent C2 alkylene oxide to 0 mole percent C3 alkylene oxide and/or C4 alkylene oxide, where the combined mole percents of C2, C3 and C4 equal 100 mole percent.

In one or more embodiments, reacting the C2 to C4 alkylene oxides with the aminated epoxy adduct includes making the reaction with a the molar ratio of C2 alkylene oxide to C3 alkylene oxide and/or C4 alkylene oxide (e.g., one of the C3 alkylene oxide, the C4 alkylene oxide or the mixture of C3 alkylene oxide and C4 alkylene oxide) from 6.5 mole percent to 57 mole percent C2 alkylene oxide to 93.5 mole percent to 43 mole percent of C3 alkylene oxide and/or C4 alkylene oxide (e.g., one of the C3 alkylene oxide, the C4 alkylene oxide or the mixture of C3 alkylene oxide and C4 alkylene oxide), where the combined mole percents of C2, C3 and C4 equal 100 mole percent.

So, for example, reacting the C2 to C4 alkylene oxides with the aminated epoxy adduct can include making the reaction with a molar ratio of 6.5 mole percent C2 alkylene oxide to 93.5 mole percent C3 alkylene oxide; making the reaction with a molar ratio of 6.5 mole percent C2 alkylene oxide to 93.5 mole percent C4 alkylene oxide; making the reaction with a molar ratio of 6.5 mole percent C2 alkylene oxide to 93.5 mole percent of a mixture of C3 alkylene oxide and C4 alkylene oxide; making the reaction with a molar ratio of 57 mole percent C2 alkylene oxide to 43 mole percent C3 alkylene; making the reaction with a molar ratio of 57 mole percent C2 alkylene oxide to 43 mole percent C4 alkylene oxide; or making the reaction with a molar ratio of 57 mole percent C2 alkylene oxide to 43 mole percent of a mixture of C3 alkylene oxide and C4 alkylene oxide.

In one or more embodiments, the mixture of C3 alkylene oxide and C4 alkylene oxide can have a mole percent ratio of C3 to C4 alkylene oxide as follows: from 100 to 0 mole percent C3 to 0 to 100 mole percent C4; from 75 to 25 mole percent C3 to 25 to 75 mole percent C4; and 50 mole percent C3 to 50 mole percent C4, where the combined mole percents of C3 and C4 equal 100 mole percent.

For one or more embodiments, the alkyl oxides, as discussed herein, e.g. C2 to C4 alkylene oxides, can be added in various ways. For example, the alkyl oxides can be added in a block sequence (a hydrophobic oxide, e.g, C3 or C4 oxide, is reacted first and followed by ethylene oxide), in a reverse block sequence (ethylene oxide is reacted first and followed by a hydrophobic oxide), or in a random block (ethylene oxide and a hydrophobic oxide are reacted at the same time). For one or more embodiments, the hydrophobic oxide block can consist of two or more hydrophobic alkylene oxides, added in random feed. For one embodiment, a block sequence is used by reacting propylene oxide first and following by ethylene oxide.

For one or more embodiments, the alkoxylation reaction includes using a catalyst. For one or more embodiments, the catalyst is a base that can be selected from the group including, but not limited to, potassium hydroxide, sodium hydroxide, sodium methanolate and combinations thereof. Other catalysts known in the art may be used. In one embodiment, the catalyst is potassium hydroxide.

The alkoxylation reaction can be carried out in a reactor, as described herein. Alkoxylation reaction pressures and reaction temperatures are known by those skilled in the art. For example, the alkoxylation reaction can have a reaction pressure within the range of from 1.0 bar to 20 bars and a reaction temperature within a range of 50° C. to 200° C.

For one or more embodiments, the demulsifier obtained by the alkoxylation reaction of the aminated epoxy adduct can be represented by a compound of Formula IV.

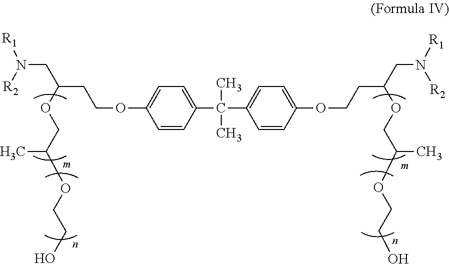

where R₁ and R₂ are each independently a proton, i.e., hydrogen, an alkyl, or a cycloalkyl group having 3 to 28 carbon atoms, n is from 1.6 to 59.0 moles, and m is from 12.4 to 85.0 moles. For one or more embodiments, R₁ and R₂ are preferably a C3 to CIO alkyl and more preferably a C4 alkyl group. For an embodiment where no propylene oxide is used, m is 0 moles and n is from 32.4 to 117.6 moles

The compound of Formula IV is shown as an example of a block copolymer formed from C2 and C3 alkylene oxides. It is appreciated, however, that other block copolymer and/or random copolymer structures, as discussed herein, are possible, where the compound of Formula IV is provided as one example of the aminated epoxy adduct of the present disclosure.

In addition to the demulsifiers provided herein, examples of additional chemistries recognized herein as being useful in the present disclosure include those found in U.S. Patent Application Publication 2006/0089426 to Haubennestel et al. and U.S. Pat. No. 7,312,260, both of which are incorporated herein by reference in their entirety. In addition, the demulsifiers provided herein may be used alone (e.g., neat) or as a blend with other demulsifiers and/or with one or more solvents, as provided herein. Examples of other demulsifiers for use with those of the present disclosure can include those found in the following patent and patent publications: PCT WO 2003/102047, PCT WO 2010/076253, PCT WO 2009/112379, U.S. Patent Application Publication 2008/0197082, U.S. Patent Application Publication 2008/0076839, U.S. Patent Application Publication 2005/0080221, PCT WO 2004/108863, U.S. Patent Application Publication 2004/0266973, PCT WO 2003/053536, EP-A 1044997(A2), U.S. Pat. No. 6,703,428, EP-A 0549918, and U.S. Pat. No. 5,401,439. These documents are incorporated herein by reverence in their entirety.

For one or more embodiments, the demulsifier can be used to destabilize a crude oil-water emulsion. As discussed herein, the method includes adding to the crude oil-water emulsion the demulsifier. For one or more embodiments, adding to the crude oil-water emulsion includes adding 0.0001 weight percent (wt. %) to 5 wt. % of the demulsifier, preferably adding 0.0005 wt. % to 2 wt. % of the demulsifier, and more preferably 0.0008 wt. % to 1 wt. % of the demulsifier, and still more preferably adding 0.001 wt. % to 0.1 wt %, the wt. % based on a total weight of the crude oil-water emulsion.

In one or more embodiments, the demulsifier of the present disclosure may be used alone (e.g, neat) or as a blend with other demulsifiers and/or with one or more solvents. In one or more embodiments, the demulsifier of the present disclosure can be used neat (e.g., not diluted or mixed with other substances) to destabilize a crude oil-water emulsion. In one or more alternative embodiments, the demulsifier of the present disclosure can be mixed with one or more solvents. The use of one or more solvents can help to homogenize the demulsifier of the present disclosure when other demulsifiers are used and/or to lower the viscosity and the pour point for improved handability. Examples of such solvents include, but are not limited to, ethanol, isopropanol, xylene, methanol and combinations thereof.

In one or more embodiments, the demulsifier of the present disclosure (neat or a blend with or without a solvent, as discussed herein) can be added to a crude oil-water emulsion at one or more points during the extraction and production of the crude oil. For example, the demulsifier of the present disclosure can be added to the produced oil-water emulsion before one or more of a treatment tank, ahead of the free-water knock-out tank or a washer tank or an electrostatic treater. So, for example, the demulsifier, or the blend with the demulsifier, can be pumped to a crude oil emulsion pipeline before the treating tanks. In various embodiments, the demulsifier of the present disclosure can be used in a blend with other demulsifiers, as discussed herein.

For one or more embodiments, the demulsifier can further include additives. These additives can include, but are not limited to, solvents, demulsification bases, cross-linkers, wetting agents, biocides, and combinations thereof. Examples of solvents for forming a solution of the demulsifier include, but are not limited to, aliphatic, paraffinic, and/or aromatic the solvents. Specific examples of solvents include methanol, ethanol, xylene, and combinations thereof. Examples of bases include, but are not limited to, polyols, polyamines esters, alkyl phenol formaldehyde resin alkoxylates, and combinations thereof. Examples of cross-linkers include, but are not limited to, toluene di-isocyanate, polyol, and combinations thereof.

### EXAMPLES

The following examples are given to illustrate, but not limit, the scope of this disclosure. Weight percent is the percentage of one compound included in a total mixture, based on weight. The weight percent can be determined by dividing the weight of one component by the total weight of the mixture and then multiplying by 100. Unless otherwise specified, all instruments and chemicals used are commercially available.

The following procedure exemplifies a standard procedure for making the demulsifier and destabilizing the crude oil-water emulsion. In, addition, one skilled in the art will appreciate that this is an exemplary procedure and that other components can be substituted or removed in the procedure to make a similar demulsifier.

### Materials

Crude oil-water emulsion (crude oil API grade 12, 40 wt. % water), collected from PETROBRAS Carmopolis field.

D.E.R™ 331 (di-epoxy resin, available from the Dow Chemical Company)

Dibutylamine, (di-amine, 99.5% grade, available from BASF).

DEMTROL™ 2020 Demulsifier (DEMTROL XN-17, available from The Dow Chemical Company).

DEMTROL™ 2025 Demulsifier (XN-25, available from The Dow Chemical Company).

DEMTROL™ 3010 Demulsifier (UA-10, available from The Dow Chemical Company).

DEMTROL™ 3020 Demulsifier (UA-1900, available from The Dow Chemical Company).

DISSOLVAN® 18 Demulsifier, available from Clariant.

TRETOLITE™ F46 Demulsifier, available from Tretolite Division of Petrolite Corporation.

Potassium Hydroxide, (catalyst, 45 wt. % in water), available from Aldrich.

Propylene oxide (alkylene oxide, technical grade), available from The Dow Chemical Company.

Ethylene oxide (alkylene oxide, technical grade), available from The Dow Chemical Company.

Kerosene, available from Merck.

Xylene, (isomer mixture, ACS reagent >98.5%), available from Aldrich.

Isopropanol, (100%, available from The Dow Chemical Company).

### Formation of Di-Aminated Epoxy Adduct

Add 374 grams (g) (1 mole (mol)) of D.E.R™ 331 to a reactor including an amine addition system (dosing funnel)). Remove the air in the reactor by vacuum and replace with nitrogen. Heat the reactor to the reaction temperature of 120° C. Feed 245 g (1.9 mol) of dibutylamine continuously to the reactor over 2 hrs. After the feed of the dibutylamine is complete, maintain the reactor at the reaction temperature for 2 hr to complete the reaction.

### Formation of Demulsifier 1 and Demulsifier 2 for Use in Demulsifying Examples 1-3

Demulsifiers 1 and 2 are formed by the alkoxylation reaction of the di-aminated epoxy adduct. The alkoxylation reaction is conducted according the following general procedure. The material quantities used to prepare Demulsifiers 1 and 2 are provided in Table I. Demulsifiers 1 and 2 are prepared as described herein are used in the subsequent Demulsifying Examples 1 and 2, discussed below.

### Demulsifier 1

Add 619 g of the di-aminated epoxy adduct to a stirred reactor. Add a quantity of 45 wt. % aqueous potassium hydroxide to the stirred reactor such that the end-of-batch potassium hydroxide concentration (calculated on the total material quantity, which is the di-aminated epoxy adduct+propylene oxide+ethylene oxide) is 3000 ppm. Close the reactor and remove the air in the reactor by vacuum and replace with nitrogen. Remove the water by vacuum to a level below 2000 ppm. Heat the reactor to the reaction temperature of 120° C. At this temperature feed 2671 g of propylene oxide to the stirred reactor in a continuous manner. After adding the propylene oxide, allow the reaction to proceed for 3 hrs (digest) to remove un-reacted propylene oxide. Heat the reactor to 140° C. and at that temperature feed 1410 g of ethylene oxide continuously to the stirred reactor in a continuous manner. After adding the ethylene oxide, allow the reaction to proceed for 1 hour (digest) to remove un-reacted ethylene oxide. Cool the reactor to 80° C. and neutralize or remove the potassium hydroxide catalyst.

### Demulsifier 2

Follow the same procedure in Demulsifier 1, except use 1881 g of propylene oxide and 2500 g of ethylene oxide.

The material quantities used to prepare Demulsifier 1 and Demulsifier 2 are provided in Table I.

TABLE I

| | Demulsifier 1 | Demulsifier 2 |
|---|---|---|
| Di-aminated Epoxy | 619 (13.2 wt. %) | 619 (12.4 wt. %) |
| Adduct (g) | | |
| Propylene Oxide (g) | 2671 (56.8 wt. %) | 1881 (37.6 wt. %) |
| Ethylene Oxide (g) | 1410 (30.0 wt. %) | 2500 (50.0 wt. %) |

Demulsifiers for Use in Comparative Example A through Comparative Example I

Comparative Examples A and G are blank samples, i.e., do not contain a demulsifier. Comparative Examples B to F, H, and I use commercially available demulsifier products. The demulsifiers used in Comparative Examples A to I are provided in Table II.

TABLE II

| Comparative Example | Demulsifier Product |
|---|---|
| Comparative Example A | none |
| Comparative Example B | DISSOLVAN ® 18 |
| Comparative Example C | DEMTROL ™ 2020 |
| Comparative Example D | DEMTROL ™ 2025 |
| Comparative Example E | DEMTROL ™ 3010 |
| Comparative Example F | DEMTROL ™ 3020 |
| Comparative Example G | none |
| Comparative Example H | DEMTROL ™ 2020 |
| Comparative Example I | DEMTROL ™ 2025 |

### Determination of the Effectiveness of the Demulsifiers

To determine the effectiveness of the demulsifiers, a bottle test evaluation was performed followed by further analysis of water in crude oil by the centrifuge method according to ASTM D 96.

### Test Methods

### Water Drop Rate

The water drop rate is determined by the bottle test, as discussed herein.

### Final BSW

The final Base water and sediments (BWS) is determined using ASTM D 96.

### Residual Emulsion

The Residual Emulsion is determined by a visual measurement analysis by observing the amount of turbidity in the interface between the separated water and the oil after the first centrifuging.

### Sediments

The Sediments is determined by a visual measurement of the centrifuge tube after the second centrifuging.

### Demulsifying Examples 1-3

The Demulsifying Examples 1-3 are performed using Demulsifier 1 (Demulsifying Examples 1 and 3) and Demulsifier 2 (Demulsifying Example 2) as prepared and described herein.

### Demulsifying Example 1

Perform Demulsifying Example 1 by using Demulsifier 1. Add ethanol to a sample of Demulsifier 1 to dilute Demulsifier 1 to 50 wt. %, which helps homogenize Demulsifier 1 in the solvent, i.e., the solvent. The amount of ethanol is determined by the equation Mₑ=[M_{b}*S_{b})*2]−5, where Mₑ equals the mass of ethanol to be added, M_{b} equals the weight of the demulsifier to be diluted, and S_{b} equals percent of active mass of the demulsifier, i.e., the amount of the demulsifier excluding solvents. Dilute Demulsifier 1 from 50% to 2% as follows: add 10 milliliters (ml) of Xylene/Isopropanaol (3:1 by volume) to 200 micro liters (μl) of Demulsifier 1. Mix to homogenize the mixture.

Add 100 mL of the crude oil-water emulsion (40 wt. % water) to a demulsification glass. Add 300 micro liters (μL) (60 parts per million (ppm)) of diluted Demulsifier 1, prepared as described above, with a micro pipette under the surface of the crude oil-water emulsion. Mix in Demulsifier 1 by intensive shaking, e.g., 100 times. Place the demulsification glass into a water bath at 60° C. and observe the water separation. Take readings of the amount of water separated at 10 minutes (min), 20 min, 30 min, 60 min, and 180 min.

After 180 min, remove the demulsification glass from the water bath. Take a sample of the oil from the top of the demulsification glass and place in an approved ASTM conical centrifuge tube to determine the water content according to ASTM D 96. Add 5 ml of kerosene to dilute the sample in the approved ASTM conical centrifuge tubes. Centrifuge the diluted sample for 10 minutes. The volume of water separated is the Water_{'} reading and observe and the amount of turbidity at the interface and record a Residual Emulsion value. Add 2 drops of TRETOLITE™ F46 (diluted at 30 wt. % concentration) to the sample and centrifuge for 10 more minutes. The volume of water separated is the Water₂ reading and observe the amount of sediments at the interface and record as a Sediments value.

BSW is calculated according to the following expression:

BSW=(Water₂−Water₁)×2

### Demulsifying Example 2

Perform Demulsifying Example 2 using the same method as Example 1, except replace Demulsifier 1 with Demulsifier 2.

### Comparative Examples A through F

The Comparative Examples A through F are performed using commercially available demulsifiers as described Table II.

### Comparative Example A

Perform Comparative Example A using the same method as Example 1 except do not use any demulsifier. Comparative Example A is a blank, i.e., no demulsifier is used.

### Comparative Example B

Perform Comparative Example B using the same method as Example 1 except replace Demulsifier 1 with DISSOLVAN® 18.

### Comparative Example C

Perform Comparative Example C using the same method as Demulsifier Example 1 except replace Demulsifier 1 with DEMTROL™ 2020.

### Comparative Example D

Perform Comparative Example D using the same method as Demulsifier Example 1 except replace Demulsifier 1 with DEMTROL™ 2025.

### Comparative Example E

Perform Comparative Example E using the same method as Demulsifier Example 1 except replace Demulsifier 1 with DEMTROL™ 3010.

### Comparative Example F

Perform Comparative Example F using the same method as Demulsifier Example 1 except replace Demulsifier 1 with DEMTROL™ 3020.

### Results

The results for Demulsifying Example (Ex.) 1 and 2 are provided in Table III.

TABLE III

| | Concentration | Time (min) | | | | | | Final | Residual |
|---|---|---|---|---|---|---|---|---|---|
| | (Conc.) | 10 | 20 | 30 | 60 | 120 | 180 | BSW | Emulsion |
| | (ppm) | Water Drop = Water Separated off (mL) | | | | | | (%) | (%) |
| Demulsifying | 60 | 1 | 4 | 5 | 6 | 9 | 10 | 7 | 8 |
| Ex. 1 | | | | | | | | | |
| Demulsifying | 60 | 0.5 | 2 | 4 | 5 | 8 | 9 | 2 | 2 |
| Ex. 2 | | | | | | | | | |

The results for Comparative Examples (Com. Ex.) A to F are provided in Table IV.

TABLE IV

| | | Time (min) | | | | | | Final | Residual |
|---|---|---|---|---|---|---|---|---|---|
| | Conc. | 10 | 20 | 30 | 60 | 120 | 180 | BSW | Emulsion |
| | (ppm) | Water Drop = Water Separated off (mL) | | | | | | (%) | (%) |
| Com. | 0 | 0 | 0 | 0 | 0 | 5 | 5.5 | 24 | 28 |
| Ex. A | | | | | | | | | |
| Com. | 60 | 1.5 | 6 | 10 | 14 | 16 | 16 | 2 | 4 |
| Ex. B | | | | | | | | | |
| Com. | 60 | 1 | 1.5 | 2 | 10 | 12 | 14 | 8 | 34 |
| Ex. C | | | | | | | | | |
| Com. | 60 | 1.5 | 3 | 4 | 12 | 14 | 16 | 8 | 28 |
| Ex. D | | | | | | | | | |
| Com. | 60 | 0.3 | 3 | 4.5 | 6 | 9 | 10 | 6 | 10 |
| Ex. E | | | | | | | | | |
| Com. | 60 | 0 | 1 | 4 | 8 | 12 | 13 | 6 | 14 |
| Ex. F | | | | | | | | | |

### Analysis of Results

In determining the effectiveness of the methods of demulsification, the lower BSW achieved is considered to illustrate higher demulsification. Comparing the final BSW of Demulsifying Example 2 (using Demulsifier 2) to the Final BSW of Comparative Example B illustrates that Demulsifying Example 2 is equal to Comparative Example B, which uses DISSOLVAN® 18 (a fully formulated demulsifier product by CLARIANT). However, the Residual Emulsion levels in the interface for Demulsifying Example 2 are lower than Comparative Example B. The lower the residual emulsion the greater the interface control and lower residual amount of water in oil as well as oil in water.

Comparing Demulsifying Example 1 (using Demulsifier 1) with Comparative Examples C to F illustrates that Demulsifying Example 1 is similar with respect to the final BSW, but has and lower Residual Emulsion level than Comparative Examples C to F. Comparing Demulsifying Example 2 (using Demulsifier 2) to comparative Examples C to F illustrates that Demulsifying Example 2 yields a lower final BSW and Residual Emulsion than Comparative Examples C to F.

### Examination of Variability of Method

To determine the variability of the method, the bottle test was done 3 times for Demulsifying Example 3 and Comparative Examples G to I.

### Demulsifying Example 3

Demulsifying Example 3 is a repeat of Demulsifying Example 1, as described herein, where the concentration of Demulsifier 1 is increased to 80 ppm (from 60 ppm) and the temperature of the water bath is increased to 80° C. (from 60° C.). Repeat three times.

### Comparative Example G

Perform Comparative Example G using the same method as Example 3 except do not use any demulsifier. Comparative Example G is a blank, i.e., no demulsifier.

### Comparative Example H

Perform Comparative Example H using the same method as Example 3 except replace Demulsifier 1 with DEMTROL™ 2020.

### Comparative Example I

Perform Comparative Example I using the same method as Example 3 except replace Demulsifier 1 with DEMTROL™ 2025.

The result for Demulsifying Example (Ex.) 3 is provided in Table V.

TABLE V

| | | Time (min) | | | | | | Final | Residual | Sedi- |
|---|---|---|---|---|---|---|---|---|---|---|
| | Conc. | 10 | 20 | 30 | 60 | 120 | 180 | BSW | Emulsion | ments |
| | (ppm) | Water Drop = Water Separated off (mL) | | | | | | (%) | (%) | (Units?) |
| Demul- | 80 | 3 | 10 | 20 | 24 | 28 | 30 | 4 | 2 | 0.6 |
| sifying | 80 | 6 | 12 | 20 | 26 | 30 | 30 | 4 | 2 | 0.6 |
| Ex. 3 | 80 | 6 | 12 | 20 | 26 | 28 | 30 | 4 | 2 | 0.8 |

The results for Comparative Example (Com. Ex.) G to I are provided in Table VI.

TABLE VI

| | | Time (min) | | | | | | Final | Residual | Sedi- |
|---|---|---|---|---|---|---|---|---|---|---|
| | Conc. | 10 | 20 | 30 | 60 | 120 | 180 | BSW | Emulsion | ments |
| | (ppm) | Water Drop = Water Separated off (mL) | | | | | | (%) | (%) | (Units?) |
| Com. Ex. G | 0 | 6 | 22 | 28 | 30 | 32 | 34 | 20 | 26 | 0.4 |
| | 0 | 6 | 18 | 22 | 26 | 28 | 30 | 20 | 24 | 0.5 |
| | 0 | 6 | 12 | 22 | 28 | 30 | 32 | 18 | 20 | 1 |
| Com. Ex. H | 80 | 4 | 14 | 20 | 28 | 36 | 40 | 13.6 | 14 | 1 |
| | 80 | 12 | 20 | 26 | 32 | 40 | 40 | 13.7 | 10 | 1 |
| | 80 | 10 | 18 | 28 | 34 | 40 | 42 | 13.6 | 10 | 1 |
| Com. Ex. I | 80 | 26 | 30 | 30 | 32 | 33 | 38 | 9.4 | 5.4 | 1 |
| | 80 | 34 | 36 | 38 | 40 | 40 | 40 | 10.4 | 5.4 | 1 |
| | 80 | 34 | 36 | 38 | 38 | 40 | 42 | 9.4 | 5.4 | 1 |

### Analysis of Results

Demulsifying Example 3 (Demulsifier 1 used at 80 ppm, at 80° C.) and Comparative Examples G, H, and I were repeated three times each to illustrate any variability in the method. It can be seen from Table V and VI that the variability in the method is very low, which is an indication that the crude oil-water emulsion is very homogeneous. The results achieved for Demulsifying Example 3 (Demulsifier 1 used at 80 ppm, at 80° C.) and Comparative Examples, G, H, and I are consistent with the Demulsifying Example 1 (Demulsifier 1 used at 60 ppm, at 60° C.) and Comparative Examples A, C, and D.

1. A method of destabilizing a crude oil-water emulsion, comprising:
adding to the crude oil-water emulsion a demulsifier obtained by an alkoxylation reaction of an aminated di-epoxy adduct, the aminated di-epoxy adduct obtained by a reaction of a di-epoxy resin and an amine.

2. The method of claim 1, where adding to the crude oil-water emulsion includes adding 0.0001 weight percent to 5 weight percent of the demulsifier based on a total weight of the crude oil-water emulsion.

3. (canceled)

4. (canceled)

5. The method of claim 1, where the alkoxylation reaction includes reacting C2 to C4 alkylene oxides with the aminated di-epoxy adduct.

6. The method of claim 5, where reacting the C2 to C4 alkylene oxides with the aminated di-epoxy adduct includes making the reaction with a molar ratio of C2 alkylene oxide to C3 alkylene oxide and/or C4 alkylene oxide from 0 mole percent to 100 mole percent of C2 alkylene oxide to 100 mole percent to 0 mole percent of C3 alkylene oxide and/or C4 alkylene oxide.

7. The method of claim 5, where reacting the C2 to C4 alkylene oxides with the aminated di-epoxy adduct includes making the reaction with a molar ratio of C2 alkylene oxide to C3 alkylene oxide and/or C4 alkylene oxide from 6.5 mole percent to 57 mole percent C2 alkylene oxide to 93.5 mole percent to 43 mole percent of C3 alkylene oxide and/or C4 alkylene oxide.

8. The method of claim 1, where the amine is a branched monoamine selected from the group consisting of di-n-butylamine, di-n-propylamine, di-n-pentylamine, di-n-hexylamine and combinations thereof.

9. The method of claim 1, where the aminated di-epoxy adduct includes two alkoxide chains, each alkoxide chain having a weight average molecular weight in a range of from 1,440 Daltons to 5,190 Daltons.

10. The method of claim 1, further including reacting the demulsifier with a cross-linker.
